(19) United States
(12) Patent Application Publication
(10) Pub. No.: US 2007/0038519 A1
(43) Pub. Date: Feb. 15, 2007

(54) Method and apparatus for supporting content purchases over a public communication network

(75) Inventors: Niklas Johansson, Stockholm (SE); Osten Forshed, Enskede (SE); Patrik Bostrom, Vallingby (SE)

Correspondence Address: ERICSSON INC., 6300 LEGACY DRIVE, M/S EVR C11, PLANO, TX, 75024, US

(73) Assignee: TELEFONAKTIEBOLAGET LM ERICSSON (PUBL), Stockholm (SE)

(21) Appl. No.: 10/550,041

(22) PCT Filed: Mar. 24, 2004
(86) PCT No.: PCT/SE04/00449

§ 371 Date: Sep. 8, 2006

(30) Foreign Application Priority Data
Mar. 27, 2003 (SE) 0300888-5
Jul. 3, 2003 (SE) 0301967-6

(51) Int. Cl. G06Q 30/00

(52) U.S. Cl. 705/26

(57) ABSTRACT

A method and apparatus for supporting a purchase of content over a public communication network from a content provider (404) to a customer (400) using an access operator for communication. The content provider receives a purchase request for content from the customer over the public network (102). The requested purchase is validated by a transaction router (406) which identifies the access operator and checks whether the operator approves the requested purchase. The content provider then delivers content to the customer if the purchase has been validated. Finally, the customer can be charged for the purchase by the access operator. The transaction router acts as a common payment mediator between plural operators and content providers, such that only one trusted relationship needs to be established with the transaction router for each operator and each content provider, respectively.

### TECHNICAL FIELD

The present invention relates generally to a method and apparatus for supporting content purchases over a public communication network upon request from customers to content providers. In particular, the invention is concerned with making purchases of content over public communication networks, such as the Internet, safe and easy.

### BACKGROUND OF THE INVENTION AND PRIOR ART

Purchasing over public communication networks such as the Internet is rapidly becoming popular and widely practised, both locally and globally. Different methods are available enabling customers to contact specific so-called “content providers” throughout the world over the Internet to buy various objects, such as articles, services and information, often generally referred to as “content”.

In this description, the phrase “content” is intended to generally represent any item, article, service, or piece of information, that can be purchased over the Internet. For example, such content may include any physical goods or articles, typically delivered by postal service, or information in the form of digital data delivered over a communication network to customer terminals, either fixed or mobile. Some content providers may also offer various communication services, such as call services, chat forums, news monitors and alerts, database searches, etc.

Most commonly, fixed computers such as PCs are used for accessing the Internet. However, wireless mobile terminals with Internet capabilities have also been introduced recently, such as WAP (Wireless Application Protocol) telephones and PDA (Personal Digital Assistant) devices. Internet browsing is a graphically based procedure for navigating the Internet when searching for specific wanted objects among the available content. A terminal user may thus contact a content server over the Internet and select entries in different menus and links or the like, displayed on the terminal screen. Each entry may contain a URL (Universal Resource Locator), identifying an Internet address of, e.g., a web page or an electronic file in any format, such as text, image, audio or video formats, which is offered by the content provider.

If the user activates (clicks) a URL, a corresponding file or page is transmitted-by means of packet based transport over the Internet and is finally downloaded into the user's receiving terminal. When audio and/or video based so-called “multimedia” content is downloaded, a streaming technique may be used, whereby the user can start playing the content at the receiving station while the file is simultaneously received. This is possible since the content is received as a data stream of packets in a sequence order corresponding to the content's playing order.

A schematic communication scenario is illustrated in FIG. 1 for purchasing content from content providers over a public communication network by means of a terminal operated by a customer, according to the prior art. In this example, a mobile terminal 100 having Internet capabilities is connected to a mobile network 102 over a radio-based air interface. The mobile network 102 uses standardised communication protocols, such as those defined for GSM, TDMA, PDC, UMTS etc, for transmission of speech and data over the air interface as well as within the network. A network gateway 104 provides connection for mobile terminals to the global Internet 106. For example, the mobile terminal 100 may be a WAP phone and the gateway 104 may be a WAP gateway. A huge number of content servers 108, of which only three are shown in FIG. 1, are further connected to the Internet 106 throughout the world.

In order to purchase content from content providers over the Internet or other communication networks, a safe and easy method is needed for the buying party to pay the amount charged by the selling party for the purchased content. The customer may thus contact any of the content servers 108 by means of the mobile terminal 100 and search for content to purchase. If an object is to be purchased at a certain price, such as an article, a service or a piece of information, different methods are currently used for paying the charged amount.

The selling content provider may send an invoice to the buying customer after each performed purchase. However, this method is relatively costly and is especially not suitable for small amounts, so-called micropayments. Moreover, there is always a risk that the customer fails or ignores to pay the invoice, resulting in further costs.

In order to establish some kind of trusted relationship, the customer may first register with the content provider to create a charging account or the like, sometimes referred to as the “e-wallet” solution. The customer can then buy on credit and receive invoices for plural purchases at a time, e.g. on a regular basis. Alternatively, the customer may provide a credit card number which can be charged for one or more performed purchases. However, customers perceive a certain threshold to register or use a credit card, in particular for micropayments. This is mainly due to the inherent insecurity of sending a credit card number over public networks such as the Internet, or simply the effort required. Customers therefore often refrain from carrying out the purchase.

Operators of access networks, such as the mobile network 102, sometimes establish business relationships with selected content providers in order to offer content to their customers, e.g. subscribers. The access operator can then charge the customers for purchased content by means of regular subscription bills or pre-paid cards, the access operator thus doing billing “on behalf”, thereby avoiding the problems mentioned above. For example, the gateway 104 of the network 102 may comprise one or more so-called portals created to support content purchases from certain selected content providers. An operator of the mobile network 102 can then charge customers for their purchases from said selected content providers, and also gain some commission revenue for providing this service. The customers will in turn not need to register with each content provider, nor send their credit card number over the Internet.

However, there are still some significant drawbacks associated with this solution. A trusted business relationship as well as specific technical interfaces must be established between each access operator and each content provider, in order to cater for billing operations and marketing activities, among other things. Furthermore, there is also generally a lack of standard technical interfaces. As a consequence, both operators and content providers must define and implement numerous technical interfaces and enter plural agreements, in order to offer even a limited range of different content to subscribers/customers in this way. This is naturally quite expensive and time consuming, and the business incentives are therefore limited for both parties, resulting in a slow market growth.

FIG. 2 illustrates the complexity of having many such separate relationships, as indicated with arrows, between plural access operators 200A, 200B, 200C . . . and plural content providers 202-1, 202-2, 202-3, 202-4 . . . .

Hence, it is highly desirable to enable customers to purchase a wide range of different content at any price over public communication networks in a convenient and safe manner by means of their existing subscriptions or pre-paid cards with operators for communication access. It is also desirable to avoid the complexity of having many separate business relationships and technical interfaces between different access operators and content providers.

### SUMMARY OF THE INVENTION

The object of the present invention is to reduce or eliminate the problems outlined above. This object and others are obtained by providing a method and apparatus for supporting purchases of content over a public communication network from a content provider to a customer using an access operator for communication.

A server controlled by the content provider, receives a purchase request for content over said public network from a terminal operated by the customer. The content provider server sends a purchase indication message to indicate said purchase request to a transaction router which has established relationships with the content provider and with the access operator, respectively. The transaction router validates the requested purchase in response to said purchase indication message, including checking whether said access operator approves the requested purchase. The content provider delivers content to the customer according to the requested purchase, if the purchase has been validated by said transaction router. The access operator can then charge the customer for the purchase, e.g. by means of a subscription bill or a pre-paid card.

The transaction router may also send a status report for the requested purchase to the content provider, before delivery of the content. The purchase status report may be sent in response to a purchase status request from the content provider.

Validating the requested purchase may further include identifying said operator based on received customer identification for said customer. The customer identification may be any of: a telephone number, a network address or a subscription identity. Validating the requested purchase may further include identifying the customer based on the received customer identification. Validating the requested purchase may further include receiving a purchase confirmation from the customer, which may be received after prompting the customer in a purchase dialogue with the transaction router. The purchase dialogue may be performed in response to receiving said purchase indication message from the content provider.

A charge request for the purchase may be sent from the content provider to the transaction router when the content has been delivered.

Each of the established relationships includes a business agreement and necessary technical interfaces.

The present invention further embraces a transaction router having an established relationship with each of a plurality of content providers and each of a plurality of access operators, respectively. The transaction router is adapted to act as a common payment mediator between said operators and said content providers for content purchases over a public communication network. The transaction router comprises means for receiving a purchase indication message from a content provider server, said purchase indication message indicating that a content purchase is requested over said public network from a terminal operated by a customer using an access operator for communication. The transaction router further comprises means for validating said requested purchase in response to the received purchase indication message, such that said content provider can deliver content to the customer according to the requested purchase if the purchase has been validated, and the customer can be charged for the purchase by the access operator.

The validation means may include means for identifying said access operator and said customer based on received customer identification, and means for checking whether the access operator approves the requested purchase, in order to validate the requested purchase before content delivery.

The transaction router may be adapted to register the purchase including storing purchase information.

The transaction router may further be adapted to send a status report for the requested purchase to the content provider, before content delivery.

The transaction router may further be adapted to send said purchase status report in response to a purchase status request from the content provider.

The transaction router may further be adapted to receive a charge request for the purchase from the content provider, as the content has been delivered.

The transaction router may further be adapted to perform identification and authorisation of the customer, in order to validate the requested purchase.

The transaction router may further be adapted to receive a purchase confirmation from the customer, in order to validate the requested purchase.

The transaction router may further be adapted to prompt the customer in a purchase dialogue to receive said purchase confirmation.

The transaction router may further be adapted to perform said purchase dialogue in response to receiving said purchase indication message from the content provider.

If the present invention is used, only one trusted relationship needs to be established with the transaction is router for each operator and each content provider, respectively.

### BRIEF DESCRIPTION OF THE DRAWINGS

The present invention will now be described in more detail and with reference to the accompanying drawings, in which:

FIG. 1 is a schematic communication scenario for purchasing content over the Internet, according to the prior art.

FIG. 2 is a schematic block diagram illustrating relationships and technical interfaces between access operators and content providers, according to the prior art.

FIG. 3 is a schematic block diagram illustrating relationships and technical interfaces between access operators and content providers, in accordance with the present invention.

FIG. 4 is a schematic communication scenario for purchasing content over a public communication network, in accordance with the present invention.

FIG. 5 is a schematic communication diagram illustrating the steps executed in an exemplary procedure for supporting a content purchase, in accordance with the present invention.

FIG. 6 is a schematic block diagram illustrating a transaction router in more detail, in accordance with the present invention.

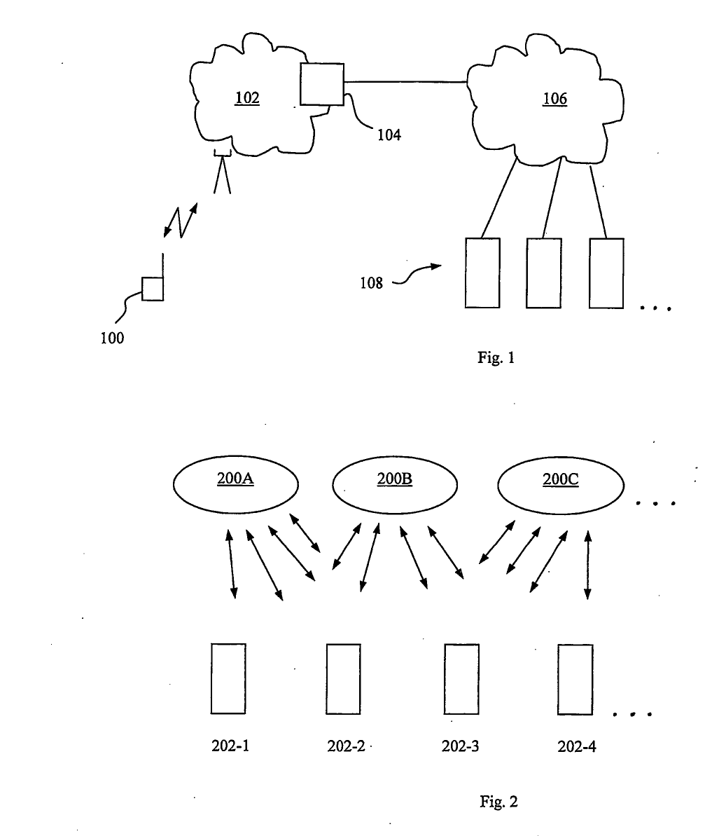

### DESCRIPTION OF PREFERRED EMBODIMENTS

In current solutions for charging customers buying content over public networks such as the Internet by means of their regular telephone subscription bill, a large number of separate relationships and technical interfaces are needed between access operators and content providers, as was illustrated in FIG. 2. The present invention is intended to reduce that number significantly, by introducing a central transaction router acting as a payment mediator between plural access operators and plural content providers. The technical features of the invented method and transaction router are outlined in the description below.

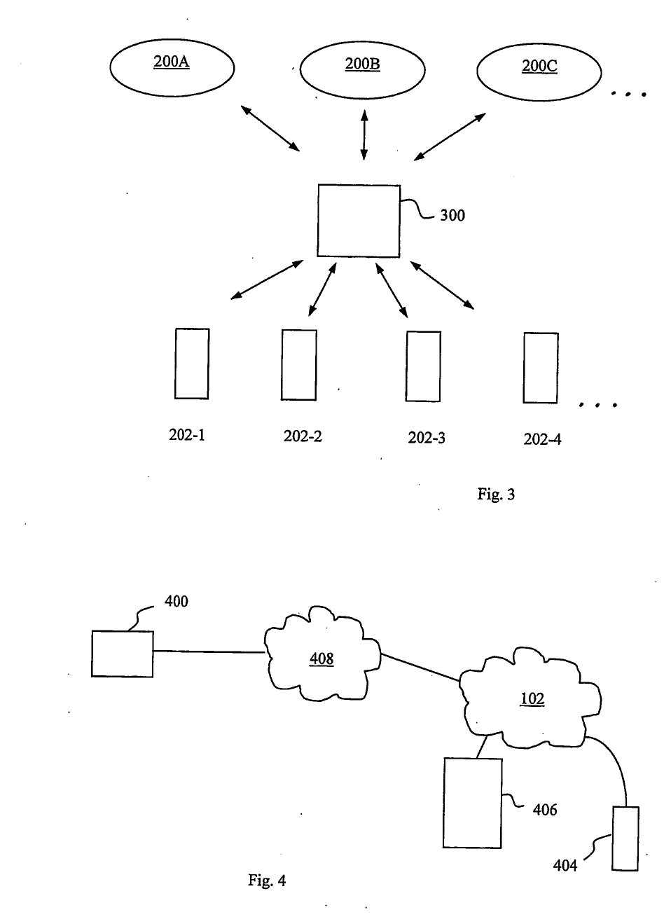

FIG. 3 illustrates schematically the reduced complexity of a transaction router 300 having a trusted relationship with each of a plurality of access operators 200A, 200B, 200C . . . and with each of a plurality of content providers 202-1, 202-2, 202-3, 202-4 . . . . Each such relationship includes necessary technical interfaces which can be individually adapted to each content provider and each access operator, respectively. Hence, only one business agreement and one set of necessary technical interfaces need to be established with the transaction router for each operator and each content provider, respectively. This arrangement results in a much lower total number of individually adapted relationships and interfaces, as indicated with arrows, compared to the conditions shown in FIG. 2. Moreover, this arrangement supports content purchases from any content provider 202 connected to the transaction router 300 by means of any of the likewise connected access operators 200.

Briefly described, and with reference to a schematic communication scenario in FIG. 4, a customer 400 is interested in buying content over a public communication network 102 from a content provider 404, as an example. The phrase “public communication network” is used herein to generally represent any public network which can be used by customers to communicate with content providers. Most typically today, the global Internet will serve as that public network, actually comprising a huge number of individual communication networks. However, any public network or combination of networks can be used within the scope of the present invention.

The customer 400 makes a purchase request to the content provider 404, and is then directed to a transaction router 406 in a purchase dialogue, in response to the purchase request. The transaction router further performs validation of the requested purchase before it can be fulfilled, including identification and authorisation of the customer 400 and/or the content provider 404. In particular, the transaction router in this case identifies the operator of the access network 408 that the customer uses for communication, e.g. by means of subscription or pre-paid card. The transaction router further checks whether the identified operator approves the purchase, e.g. with respect to his/her subscription and/or current credibility with the operator, or in some cases depending on the nature of the requested content.

There may exist various different reasons for not approving the requested purchase. For example, a predefined credit limit may be exceeded which has been granted to the customer by the operator for doing purchases over the public network. Further, the customer may have been blocked from doing any purchases in this way, e.g., due to previously unpaid bills or the like. In other examples, the operator may not allow content delivery from certain “black-listed” content providers, or may not allow delivery of certain types of content to specific customers, etc.

The above-described approval check may in practice be performed either by requesting approval from the operator or by retrieving a database or the like, not shown, holding such information. Furthermore, the customer 400 is prompted by the transaction router 406 in the purchase dialogue to confirm the purchase. Then, the transaction router provides a purchase status to inform the content provider 404 whether the purchase has been approved and confirmed.

If the purchase has been successfully validated, the content provider can then deliver the requested content to the customer and later receive payment from the transaction router. The transaction router will in turn receive payment from the customer's access operator for the purchase, optionally including a commission. Eventually, the customer will pay for the purchase by means of his/her regular subscription bill, or a separate bill, or a pre-paid card, as charged by the operator.

In this way, the operator can charge the customer on behalf of a potentially great number of content providers. A great benefit for the customer is that a bill or the like is provided by the operator with which he/she already has established a trusted relationship, and typically also a safe payment mechanism. Plural such purchases, involving small or large amounts, from different content providers can also be collected and be charged for collectively, e.g. on the same bill.

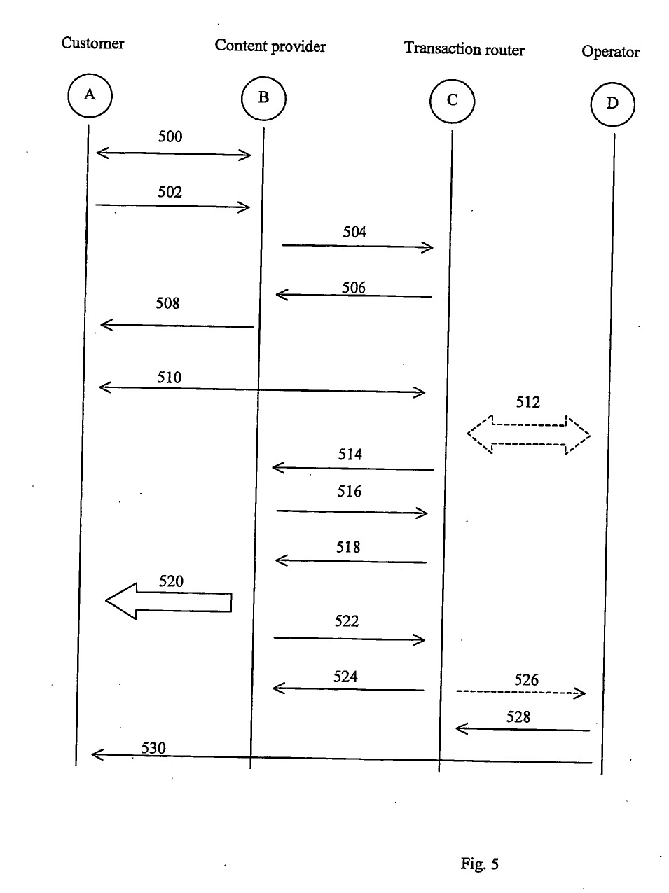

A more detailed example will now be described of a procedure for supporting a content purchase over a public communication network, in accordance with the present invention. FIG. 5 illustrates a communication diagram involving various messages exchanged between a customer A operating a suitable communication terminal, a content provider B controlling one or more servers, a transaction router C, and an access operator D which the customer uses for communication, e.g. by means of subscription or pre-paid card. A regular fixed or mobile telephone subscription can preferably be used, but any other type of subscription enabling telecommunication may also be used, such as for Internet access, cable television, etc. However, the present invention is not limited to any particular type of payment agreement between the customer and the access operator. The content provider B and the operator D, respectively, communicates with the transaction router C by means of suitable receiving/transmitting means and predefined interfaces specifically adapted therefor, as mentioned above.

The communication terminal operated by the customer A is used for sending and receiving various messages indicated in FIG. 5, and may be any type of user terminal or device capable of telecommunication, such as a PC, a mobile station, a work station, a game station or a TV set. Further, a content provider server may be used for communicating messages with the content provider B, as indicated in FIG. 5. In general, any suitable known methods, systems and equipment enabling such communication may be used for the present invention, and will therefore not be described here in detail.

A first step 500 generally illustrates that the customer A searches for content to buy in a communication with the content provider B over a public network. During this step, the content provider may offer the customer to purchase certain content and to be charged for the purchase by his/her access operator D, by means of e.g., a regular telephone bill or a pre-paid card. After finding some desirable content, the customer eventually sends a purchase request, in a next step 502, to the content provider B. However, before the content provider B delivers the requested content, the purchase request must be validated by utilizing the transaction router C in the following manner.

Thus, in response to the purchase request, the content provider B first sends a purchase indication message to the transaction router C in a step 504. In response to the purchase indication message, the transaction router will then validate the requested purchase, and also start a purchase dialogue with the customer. Validating the purchase includes verifying the customer A and/or the content provider B, checking whether the operator D approves the purchase, and asking the customer to confirm his/her requested purchase.

The purchase indication message sent in step 504 contains information on the requested content, such as identification and price, and authentication specifications for the content provider B, such as a Username/Password combination. The purchase indication message may further comprise a first URL, which is a network address to be used later for redirecting the customer back to the content provider B after the purchase dialogue. In practice, the purchase indication message may be implemented as a “session request” or a “validation request” from the content provider.

In response to receiving the purchase indication message, the transaction router C sends session information to the content provider B in a step 506, concerning the purchase dialogue to be executed with the customer A. The session information includes an assigned session ID (identity) and a second URL, which is a network address for directing the customer to the transaction router. The purchase indication message also triggers the transaction router to validate the requested purchase, to be further described below.

The content provider sends the second URL to the customer in a step 508, in order to connect the customer with the transaction router. Next, the customer is connected to the transaction router by using the received URL, and a purchase dialogue is performed between the transaction router C and the customer A in a step 510. During this dialogue, the transaction router preferably presents purchase data to the customer and prompts him/her to confirm the purchase.

If the customer operates a mobile WAP terminal, the WAP gateway of the access network used may further provide information to the transaction router regarding identity and capabilities of the WAP terminal and of the communication channel used, e.g. included in a so-called “cookie” or in a HTTP header. Such information can be useful if the requested content comprises digital data to be delivered in a suitable format to the customer's WAP terminal.

According to different embodiments of the present invention, the customer may be prompted to confirm the purchase during step 512, e.g., by clicking “confirm” on the terminal screen, or by sending a specific message to a certain telephone number. For example, if the customer operates a mobile terminal, he/she may be prompted to confirm by sending an SMS (Short Message Service) containing a specific code to a given telephone number.

Some time during the above-described procedure, the transaction router C checks whether the operator D approves the purchase, which is indicated by a step 512, either by contacting the operator D or by retrieving a database or the like, as described above. In order to do that, some kind of identification means for the customer and/or the used terminal is needed, such as a telephone number, a network address or a subscription identity, from which the transaction router can identify the operator D and also the customer. In different embodiments, such customer identification may have been included in the purchase request received from the customer in step 502 and forwarded to the transaction router, e.g. in the purchase indication message sent in step 504. Alternatively, the customer identification means may have been provided from the customer's terminal during the purchase dialogue in step 510. The transaction router thus checks in step 512 whether the customer is authorised to make the purchase and to be charged for the purchase by the operator D, as described above.

If the customer has been properly authorised and the requested purchase has been confirmed, the transaction router C registers the purchase and directs the customer A back to the content provider B in a step 514 by providing the first URL received in step 504. Registering the purchase includes storing various purchase information, such as transaction ID, content ID, customer ID, content provider ID, customer authorisation, content price, etc. This information can be retrieved later for charging the operator D and paying the content provider B.

Before delivering the requested content to the customer A, the content provider B sends a request for purchase status to the transaction router C in a step 516, in order to have the purchase validated. In one embodiment, the above-mentioned customer identification means may be provided to the transaction router during this step. The transaction router then retrieves the requested purchase status from the stored purchase information and sends it to the content provider in a step 518. The requested purchase status may include any of the above-mentioned stored purchase information as well as the status of operator's approval, customer authorisation and confirmation.

If the purchase has been properly validated by means of the provided purchase status, content according to the requested purchase can be delivered to the customer A from the content provider B, in a step 520. After delivery, the content provider B may send a charge request 522 to the transaction router C for the delivered content. The transaction router may then pay or settle the charged amount with the content provider, as indicated in a step 524. In practice, the charged amount can be settled with the content provider in different ways. Thus, any suitable routines may be used to handle steps 522 and 524, such as making plural charges and payments collectively, e.g., on a regular basis. The transaction router further informs the operator D on the paid amount, optionally including an added commission, which is indicated in a further step 526. Different routines for this are also possible, such as providing so-called Charging Data Records (CDR) to the operator, either after each performed purchase, or on a regular basis containing information on a plurality of transactions for plural customers subscribing with the operator.

The operator then duly pays or settles the charged amount with the transaction router C, in a step 528. The operator also eventually charges the customer by means of a bill, e.g. a regular telephone bill, for the purchase costs and optionally a further added commission, in a final step 530.

The above-described example of supporting a purchase over a public communication network can be modified in different ways, within the scope of the present invention, such as the sequence order of various steps. For example, the transaction router may perform the step 512 of checking the operator's D approval of the requested purchase any time after step 504 of receiving the purchase indication message, but before step 518 of providing purchase status, e.g. depending on when the customer identification is received. In particular, any suitable routines and mechanisms may also be used for charging and transferring various payments, such as those involving steps 522-530 in the above-described example. The steps 522 and 526, respectively, may further be omitted if the respective charged amounts have been forwarded in any earlier steps, e.g. in step 504, 506 or 516, or in any other way. Further, purchase status may be provided automatically to the content provider B when the customer A is directed back to the content provider B in step 514, such that the status requesting step 514 can be omitted.

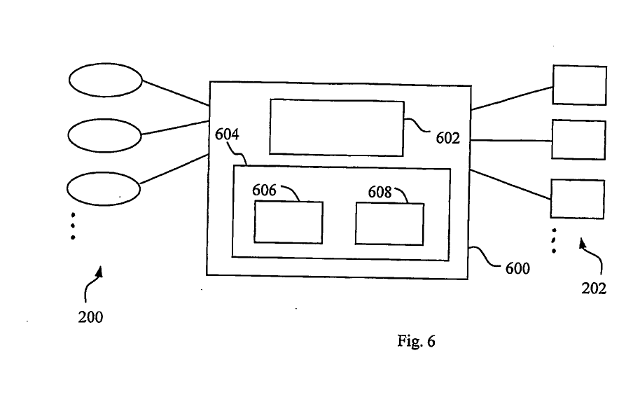

FIG. 6 illustrates a transaction router in more detail, in accordance with the present invention. The transaction router 600 is connected to and has an established relationship with each of a plurality of content providers 202 and each of a plurality of access operators 200, respectively. The transaction router is adapted to act as a common payment mediator between the operators 200 and the content providers 202 for content purchases over a public communication network.

The transaction router 600 comprises receiving means 602 for receiving a purchase indication message from one of the content providers, said purchase indication message indicating that a content purchase is requested over the public network from a terminal operated by a customer using an access operator for communication.

The transaction router 600 also comprises purchase validation means 604 for validating said requested purchase in response to said purchase indication message, such that said content provider can deliver content to the customer according to the requested purchase, if the purchase has been validated, and the customer can be charged for the purchase by the access operator. The purchase validation means 604 includes identification means 606 for identifying said access operator and said customer based on received customer identification, and checking means 608 for checking whether the access operator approves the requested purchase, in order to validate the requested purchase before delivery.

In the described inventive solution, customers will be able to select from a much broader range of different content offered by a potentially great number of content providers. Payment can be carried out in a convenient and safe manner by means of, e.g., regular subscription bills or pre-paid cards from an access operator. These benefits will make Internet purchasing more attractive to customers, thereby promoting the market growth. Furthermore, content providers will be able to use plural operators for marketing and selling their products in the described manner to a great number of customers, by establishing only one relationship, including technical interfaces, with the transaction router.

The present invention enables access operators in turn to generate revenues from increased traffic in their access networks or the like, and further by adding commissions when doing the above-described billing on behalf.

While the invention has been described with reference to specific exemplary embodiments, the description is only intended to illustrate the inventive concept and should not be taken as limiting the scope of the invention. Various alternatives, modifications and equivalents may be used without departing from the spirit of the invention, which is defined by the appended claims.

1. A method of supporting purchases of content over a public communication network from a content provider to a customer using an access operator for communication, characterized by the following steps:
receiving, at a server controlled by the content provider, a purchase request for content over said public network from a terminal operated by the customer,
said content provider server sending a purchase indication message to indicate said purchase request to a transaction router which has established relationships with the content provider and with the access operator, respectively,
said transaction router validating the requested purchase in response to said purchase indication message, including checking whether said access operator approves the requested purchase, and
said content provider delivering content to the customer according to the requested purchase, if the purchase has been validated by said transaction router,
such that said access operator can charge the customer for the purchase.

2. A method according to claim 1, characterized in that said access operator charges the customer for the purchase by means of a subscription bill or a pre-paid card.

3. A method according to claim 1 or 2, characterized in that the transaction router sends a status report for the requested purchase to the content provider, before delivery of the content.

4. A method according to claim 3, characterized in that said purchase status report is sent in response to a purchase status request from the content provider.

5. A method according to any of claims 1-4, characterized in that validating the requested purchase further includes identifying said operator based on received customer identification for said customer.

6. A method according to claim 5, characterized in that said customer identification is any of: a telephone number, a network address or a subscription identity.

7. A method according to claim 5 or 6, characterized in that validating the requested purchase further includes identifying the customer based on said received customer identification.

8. A method according to any of claims 1-7, characterized in that validating the requested purchase further includes receiving a purchase confirmation from the customer.

9. A method according to claim 8, characterized in that said purchase confirmation is received after prompting the customer in a purchase dialogue with the transaction router.

10. A method according to claim 9, characterized in that said purchase dialogue is performed in response to receiving said purchase indication message from the content provider.

11. A method according to any of claims 1-10, characterized in that a charge request for the purchase is sent from the content provider to the transaction router when the content has been delivered.

12. A method according to any of claims l-11, characterized in that each of said established relationships includes a business agreement and necessary technical interfaces.

13. A transaction router having an established relationship with each of a plurality of content providers and each of a plurality of access operators, respectively, characterized in that the transaction router is adapted to act as a common payment mediator between said operators and said content providers for content purchases over a public communication network, the transaction router comprising:
means for receiving a purchase indication message from a content provider server, said purchase indication message indicating that a content purchase is requested over said public network from a terminal operated by a customer using an access operator for communication, and
means for validating said requested purchase in response to the received purchase indication message, such that said content provider can deliver content to the customer according to the requested purchase if the purchase has been validated, and the customer can be charged for the purchase by the access operator.

14. A transaction router according to claim 13, characterized in that said validation means includes means for identifying said access operator and said customer based on received customer identification, and means for checking whether the access operator approves the requested purchase, in order to validate the requested purchase before content delivery.

15. A transaction router according to claim 13 or 14, characterized in that the transaction router is adapted to register the purchase including storing purchase information.

16. A transaction router according to any of claims 13-15, characterized in that the transaction router is adapted to send a status report for the requested purchase to the content provider, before content delivery.

17. A transaction router according to claim 16, characterized in that the transaction router is further adapted to send said purchase status report in response to a purchase status request from the content provider.

18. A transaction router according to any of claims 13-17, characterized in that the transaction router is further adapted to receive a charge request for the purchase from the content provider, as the content has been delivered.

19. A transaction router according to any of claims 13-18, characterized in that the transaction router is further adapted to perform identification and authorisation of the customer, in order to validate the requested purchase.

20. A transaction router according to any of claims 13-19, characterized in that the transaction router is further adapted to receive a purchase confirmation from the customer, in order to validate the requested purchase.

21. A transaction router according to claim 20, characterized in that the transaction router is further adapted to prompt the customer in a purchase dialogue to receive said purchase confirmation.

22. A transaction router according to claim 21, characterized in that the transaction router is further adapted to perform said purchase dialogue in response to receiving said purchase indication message from the content provider.

23. A transaction router according to any of claims 13-22, characterized in that each of said established relationships includes a trusted business agreement and any necessary technical interfaces.
